(19) United States
(12) Patent Application Publication
(10) Pub. No.: US 2018/0303136 A1
(43) Pub. Date: Oct. 25, 2018

(54) NOODLE VENDING MACHINE AND CONTROL METHOD THEREOF

(71) Applicant: NOODLE TIME HOLDINGS LIMITED, Kowloon (HK)

(72) Inventors: Ji MA, Kowloon (HK); Li-Ming SUNG, Kowloon (HK); Szu-Chou PENG, Kowloon (HK); Kim-Kwong CHOW, Kowloon (HK)

(21) Appl. No.: 15/493,135

(22) Filed: Apr. 21, 2017

(51) Int. Cl. A23L 7/113; A23L 5/10; A47J 27/62; G07F 13/10

(52) U.S. Cl. CPC A23L 7/113; A23L 5/13; A47J 2027/006; G07F 13/10; A23V 2002/00; A47J 27/62

(57) ABSTRACT

A noodle vending machine and a control method thereof are disclosed. The noodle bowl is rotated out through the rotary noodle selector and taken through the noodle picking mechanism. Then, it is hooked out and carried to the X-Y axis noodle provide. The noodle bowl is lifted through the X-Y axis noodle provider and simultaneously the soup injection mechanism is lowered. Steam is sent to the soup injection mechanism to thaw the noodle bowl. A warm tank is heated and the hot water is injected into a mixing can and simultaneously the soup base is injected into the mixing can. A mixing motor is started to mix the hot water and the soup base. After being mixed, the soup base is sent to the soup injection mechanism and injected into the noodle bowl. Thus, a noodle bowl with soup using steam cooking is completed.

### BACKGROUND OF THE INVENTION

### Field of the Invention

The present invention relates to a vending machine and in particular to a vending machine selling noodles.

### Description of Prior Art

With the continuous progress of technology, the vending machine selling cold drinks have developed into the vending machine providing hot food mixed with soup.

In a prior art vending machine which provides hot food mixed with soup, the fresh ingredients and soup are kept refrigerated in the cooler compartment. Then, the concentrated soup is injected into the soup cooking canister. The fresh ingredients in the bag are placed in the ingredient cooking canister after the bag is cut by the cutting mechanism. After that, the hot water in the hot water tank is injected into the soup cooking canister and the ingredient cooking canister. When the customer orders, the automatic bowl providing unit will send a bowl through tracks to the carrying mechanism. After the fresh ingredients are cooked and the diluted soup is boiled, the inversing mechanism reverses the soup cooking canister and the ingredient cooking canister to pour the cooked ingredients and the boiled soup into the bowl. In this way, the hot food mixed with soup is completed and then is carried to the pickup area for the customer.

Though the above-mentioned vending machine can provide the hot food mixed with soup for the customer in a short time, the complexity of the internal design of this vending machine causes some problems in the operation. If the internal design can be further improved and simplified to mitigate the problems, the vending machine providing hot food mixed with soup will further meet the needs of the customer.

### SUMMARY OF THE INVENTION

The main objective of the present invention is to provide a brand-new noodle vending machine which moves out a noodle bowl by rotation and hooks the noodle bowl to an X-Y axis noodle provider. Next, in a way of the X-Y axis, the noodle bowl is sent to a soup injection mechanism which then injects steam into the noodle bowl to thaw and cook the ingredients. After that, the soup injection mechanism injects the seasoned soup base into the noodle bowl. Thus, a noodle bowl with soup is completed.

To achieve the above objective, the present invention provides a control method of a noodle vending machine. The control method of steaming and cooking a noodle bowl comprises the steps of rotating out the noodle bowl through the rotary noodle selector, taking out the noodle bowl through the noodle picking mechanism after the noodle bowl is rotated out, hooking out the noodle bowl through the bowl transfer mechanism, carrying the noodle bowl to the X-Y axis noodle provider after the noodle bowl is hooked out, lifting the noodle bowl through the X-Y axis noodle provider and simultaneously lowering the soup injection mechanism above the noodle bowl, sending steam to the soup injection mechanism through the automatic steam adding mechanism and then thawing the noodle bowl through the soup injection mechanism. During the process of the above steps, the steps below are performed in parallel with the process. The steps are heating a warm tank of the heating-and-mixing mechanism, injecting hot water into a fixed quantity can of the heating-and-mixing mechanism, injecting soup base into a mixing can of the heating-and-mixing mechanism through the soup base compressing mechanism and the soup base fixed quantity provider according to the selected flavor and amount of the soup base, injecting the hot water in the fixed quantity can into the mixing can, mixing the hot water and the soup base in the mixing can by starting a mixing motor of the heating-and-mixing mechanism, sending the soup base to the soup injection mechanism after the soup base is mixed, and injecting the soup base into the noodle bowl through the soup injection mechanism. Thus, the steam cooking of the noodle bowl is completed.

In an embodiment of the present invention, the control method further comprises the step of removing the moisture in the noodle bowl through a dehumidifier after the noodle bowl is thawed.

In an embodiment of the present invention, in the step of heating a warm tank of the heating-and-mixing mechanism, pure water is injected into a heater of the heating-and-mixing mechanism through a water pump and is heated instantly to 100° C. which is injected into the warm tank by opening a solenoid valve and is kept at a temperature ranging from 95° C. to 98° C.

In an embodiment of the present invention, the control method further comprises the step of restoring the soup injection mechanism after the soup base is injected into the noodle bowl.

In an embodiment of the present invention, the control method further comprises the step of labeling the noodle bowl using a labeling mechanism after the noodle bowl is injected with the soup base and is then carried to a bowl outlet by the X-Y axis noodle provider.

In an embodiment of the present invention, the control method further comprises the step of driving a panel to open using a panel driving mechanism after the noodle bowl is labeled.

In an embodiment of the present invention, the control method further comprises the step of rotating out chopsticks and a seasoning bag using a chopstick provider when the noodle bowl is carried to the bowl outlet.

To achieve the above objective, the present invention provides a noodle vending machine which steams and cooks a noodle bowl. The noodle vending machine comprises a rotary noodle selector, a noodle picking mechanism, a bowl transfer mechanism, an X-Y axis noodle provider, a soup injection mechanism, an automatic steam adding mechanism, a heating-and-mixing mechanism, a soup base compressing mechanism, and a soup base fixed quantity provider. The rotary noodle selector is installed in a refrigerator of the noodle vending machine. The noodle picking mechanism is disposed below the rotary noodle selector. The bowl transfer mechanism is disposed at a side of the noodle picking mechanism. The X-Y axis noodle provider is disposed at a side of the bowl transfer mechanism. The soup injection mechanism is located above the X-Y axis noodle provider. The automatic steam adding mechanism is disposed at a side of the soup injection mechanism and connected to the soup injection mechanism. The heating-and-mixing mechanism is disposed at another side of the soup injection mechanism and connected to the soup injection mechanism. The soup base compressing mechanism is disposed at a side of the heating-and-mixing mechanism and connected to the heating-and-mixing mechanism. The soup base fixed quantity provider is disposed at a side of the soup base compressing mechanism and connected to the heating-and-mixing mechanism. The noodle picking mechanism takes out the noodle bowl rotated out by the rotary noodle selector. Then, the bowl transfer mechanism hooks the noodle bowl to the X-Y axis noodle provider. Next, the X-Y axis noodle provider lifts the noodle bowl and simultaneously the soup injection mechanism is lowered. After that, the automatic steam adding mechanism sends steam to the soup injection mechanism to thaw the noodle bowl. The soup base compressing mechanism and the soup base fixed quantity provider inject the soup base into the heating-and-mixing mechanism for mixing when the heating-and-mixing mechanism is heated and then the heating-and-mixing mechanism sends the soup base to the soup injection mechanism which injects the soup base into the noodle bowl.

In an embodiment of the noodle vending machine of the present invention, the rotary noodle selector has a fixture having a lower fixing plate and an upper fixing plate. The lower fixing plate has an outlet and the upper fixing plate has a plurality of inlets. The fixture is pivoted to a rotary set having two rotary disks; the two rotary disks individually have a plurality of throughholes corresponding to each other. A plurality of positioning rods is disposed on the perimeters of the throughholes to form a plurality of spaces for accommodating the noodle bowl. Also, a step motor is disposed on the lower fixing plate and connected to a gear engaged with a gear surface on the perimeter of the rotary disk under the rotary set such that the gear drives the gear surface to rotate the rotary set.

In an embodiment of the noodle vending machine of the present invention, the noodle picking mechanism has a bottom plate on which a transmission set and a step motor are disposed. A supporting platform is pivoted to the transmission set such that the transmission set drives the supporting platform to move vertically through the rotation of the step motor. A sensor is disposed at a side of the transmission set to sense a position signal when the supporting platform is positioned.

In an embodiment of the noodle vending machine of the present invention, the bowl transfer mechanism has a fixing frame on which a holding plate is disposed. A step motor is disposed on a side of the fixing frame and a rotary arm is connected to a transmission shaft of the step motor. The rotary arm has a hook portion shaped like a sickle and the rotary arm is driven and rotated by the step motor such that the noodle bowl on the supporting platform is hooked to the holding plate and then to the X-Y axis noodle provider. Besides, a transition mechanism is disposed on a side of the fixing frame.

In an embodiment of the noodle vending machine of the present invention, the X-Y axis noodle provider has an X-axis moving mechanism comprising two X-axis linear guides. An X-axis transmission shaft and an X-axis step motor connected to the X-axis transmission shaft are disposed between the two X-axis linear guides; the X-axis step motor drives a moving platform of a Y-axis moving mechanism pivoted to the X-axis transmission shaft. The Y-axis moving mechanism comprises two Y-axis linear guides between which a Y-axis transmission shaft and a Y-axis step motor connected to the Y-axis transmission shaft are disposed. A supporting plate is pivoted to the Y-axis transmission shaft and has a water collecting funnel thereon. A plate-like filter is disposed on the water collecting funnel and a bucket is disposed at a side of the water collecting funnel. Also, a plurality of sensors is disposed at a side of the Y-axis linear guide to sense an up-location or a down-location of the supporting plate.

In an embodiment of the noodle vending machine of the present invention, the soup injection mechanism has a fixing plate. A servo motor and a transmission shaft driven by the servo motor are disposed on a side of the fixing plate. The transmission shaft is pivoted to a moving block and a sliding block is attached to a side of the moving block. The sliding block is pivoted to a linear track and an injection pipe is attached to the moving block. A soup base connector and a steam connector are disposed at one end of the injection pipe such that when the servo motor drivers the transmission shaft, the moving block moves the injection pipe vertically.

In an embodiment of the noodle vending machine of the present invention, the automatic steam adding mechanism has a holding plate on which a balance plate, an overpressure vent, and a water addition connector are disposed. A steam can is disposed at one end of a side of the balance plate and a counterweight is disposed at the other end of the side of the balance plate. A trigger plate is disposed on another side of the balance plate and corresponds to a sensing switch on the holding plate.

In an embodiment of the noodle vending machine of the present invention, the heating-and-mixing mechanism comprises at least a heater, a warm can, a fixed quantity can, a mixing can, a mixing motor, and a solenoid valve.

In an embodiment of the noodle vending machine of the present invention, the soup base compression mechanism has a frame on which two opposite side plates are disposed. A transmission mechanism and a servo motor are disposed on the outer side of one of the two opposite side plates such that the servo motor drives the transmission mechanism to move a plurality of soup stretchable mechanisms on the inner side of the one of the two opposite side plates along liner tracks. Each of the soup stretchable mechanisms has a transmission gear, a stretchable tube, and a servo motor. When the transmission mechanism moves and positions one of the soup stretchable mechanisms, the servo motor of the positioned soup stretchable mechanism drives the transmission gear to cause the stretchable tube to stretch to press against a soup base can on the other of the two opposite side plates such that the soup base in the soup base can is outputted and injected into the heating-and-mixing mechanism.

In an embodiment of the noodle vending machine of the present invention, the soup base fixed quantity provider has a servo motor driving a screw shaft to slide a press block on a linear guide such that one end of the press block pushes a press rod which squeezes seasoning out of a seasoning can to the heating-and-mixing mechanism. An inductive switch is disposed at a side of the press block such that when the press block moves and a top stopper on the press block triggers the inductive switch, the servo motor stops.

In an embodiment of the present invention, the noodle vending machine further comprises a chopstick provider disposed at a side of a bowl outlet of the noodle vending machine and having a stainless steel platform with a rotary store tank in which a chopstick area and a seasoning bag area are disposed. An electrical guider rotating the rotary store tank, a position sensor sensing the rotary position of the rotary store tank, and an electronic lock locking the rotary store tank are disposed inside the platform.

In an embodiment of the present invention, the noodle vending machine further comprises a panel driving mechanism disposed at a side of a bowl outlet of the noodle vending machine and having a servo motor driving a screw shaft which drives a contact arm. One end of the contact arm presses against a linear bearing such that the linear bearing moves a panel vertically along a track bearing. Besides, two opposite inductive switches are disposed beside the screw shaft to sense a position signal when the contact arm moves vertically and then the servo motor stops driving the screw shaft based on the position signal.

In an embodiment of the present invention, the noodle vending machine further comprises a labeling mechanism which labels the noodle bowl when the noodle bowl is carried to a bowl outlet by the X-Y axis noodle provider.

### BRIEF DESCRIPTION OF DRAWING

FIG. 1 is a right front perspective view of the internal structure of the noodle vending machine of the present invention;

FIG. 2 is a left front perspective view of the internal structure of the noodle vending machine of the present invention;

FIG. 3 is a right rear perspective view of the internal structure of the noodle vending machine of the present invention;

FIG. 4 is a left rear perspective view of the internal structure of the noodle vending machine of the present invention;

FIG. 5 is a perspective view of the rotary noodle selector in FIGS. 1-4;

FIG. 6 is a perspective view of the noodle picking mechanism in FIGS. 1-4;

FIG. 7 is a perspective view of the bowl transfer mechanism in FIGS. 1-4;

FIG. 8 is a perspective view of the X-Y axis noodle provider in FIGS. 1-4;

FIG. 9 is a perspective view of the soup injection mechanism in FIGS. 1-4;

FIG. 10 is a perspective view of the automatic steam adding mechanism in FIGS. 1-4;

FIG. 11 is a perspective view of the heating-and-mixing mechanism in FIGS. 1-4;

FIG. 12 is a front perspective view of the soup base compression mechanism in FIGS. 1-4;

FIG. 13 is a rear perspective view of the soup base compression mechanism in FIG. 12;

FIG. 14 is a perspective view of the soup base fixed quantity provider in FIGS. 1-4;

FIG. 15 is a perspective view of the chopstick provider in FIGS. 1-4;

FIG. 16 is a perspective view of the panel driving mechanism in FIGS. 1-4; and

FIG. 17 is the flowchart of the control method of the noodle vending machine of the present invention.

### DETAILED DESCRIPTION OF THE INVENTION

The technical features and details of the present invention are described below in reference to accompanying figures.

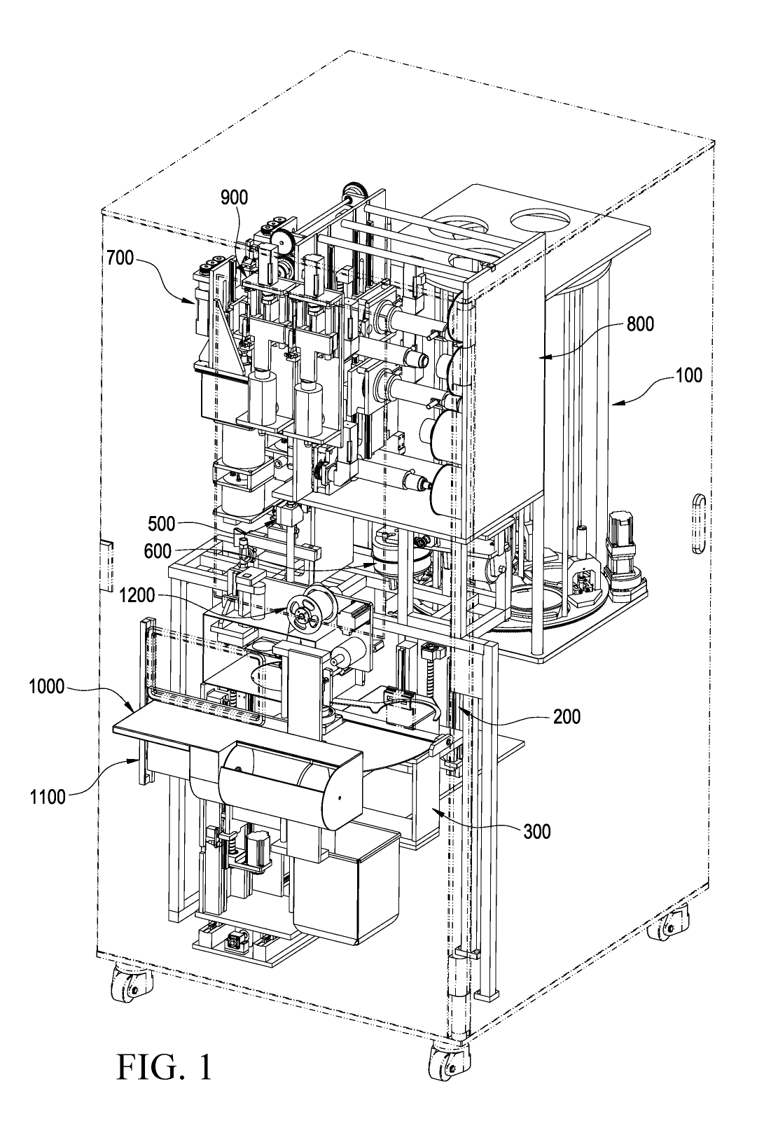

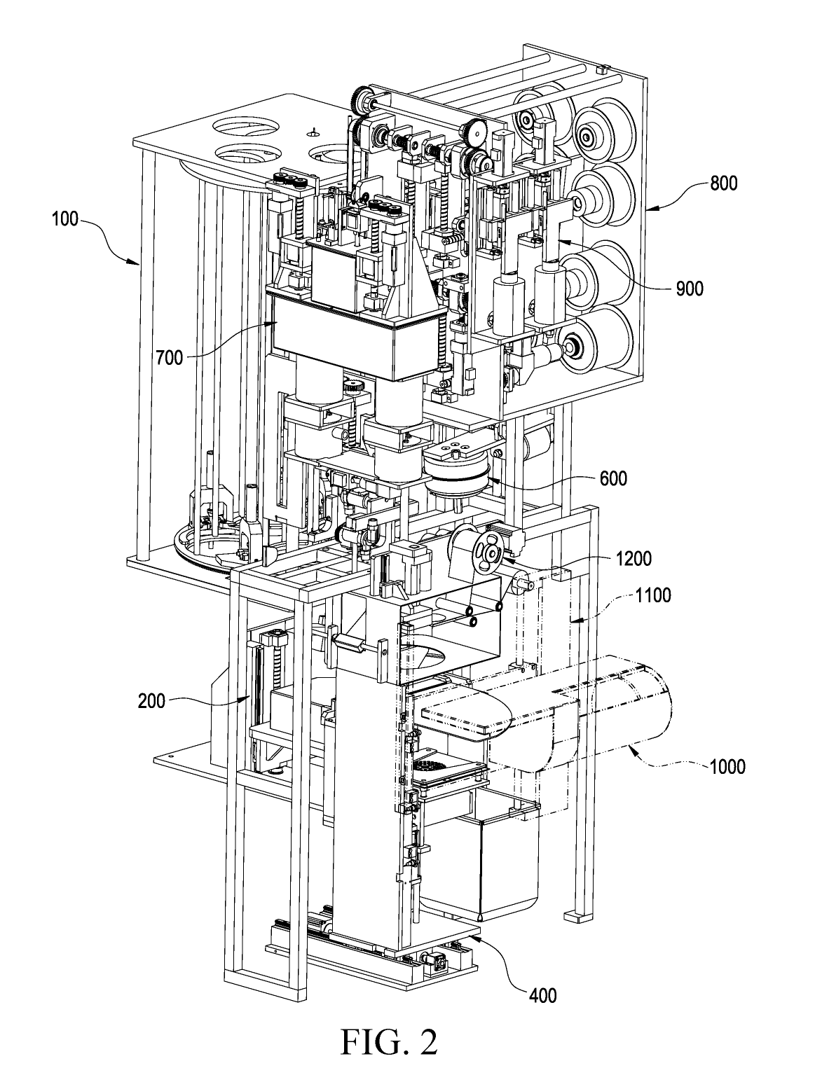

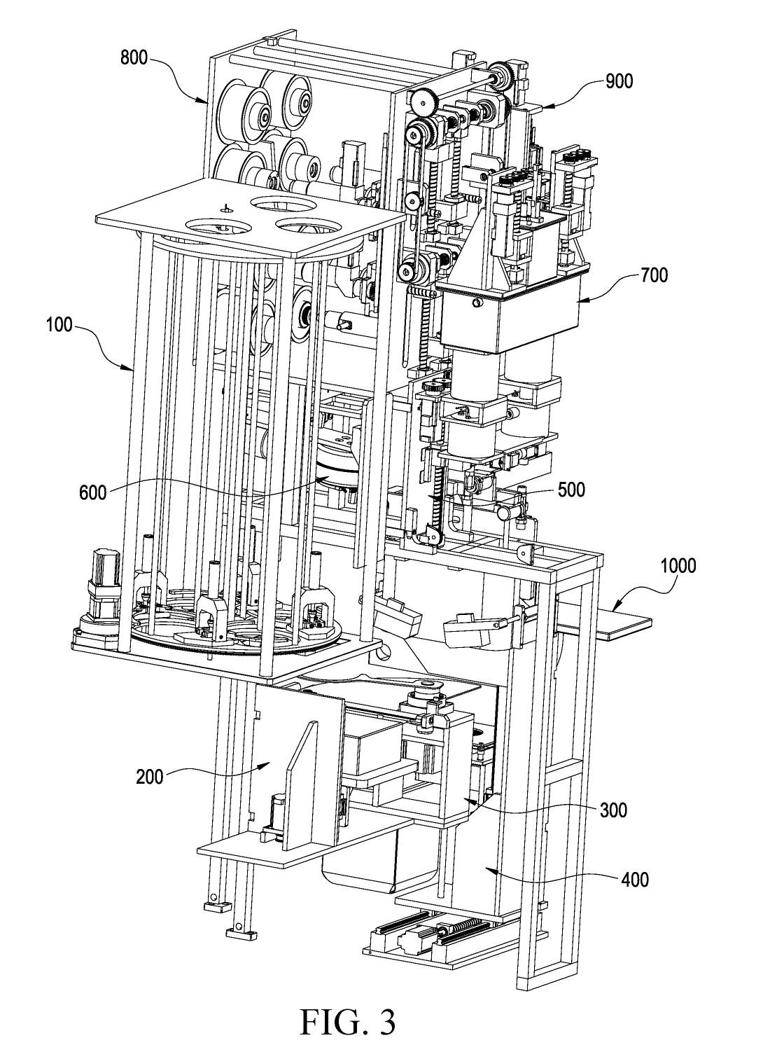

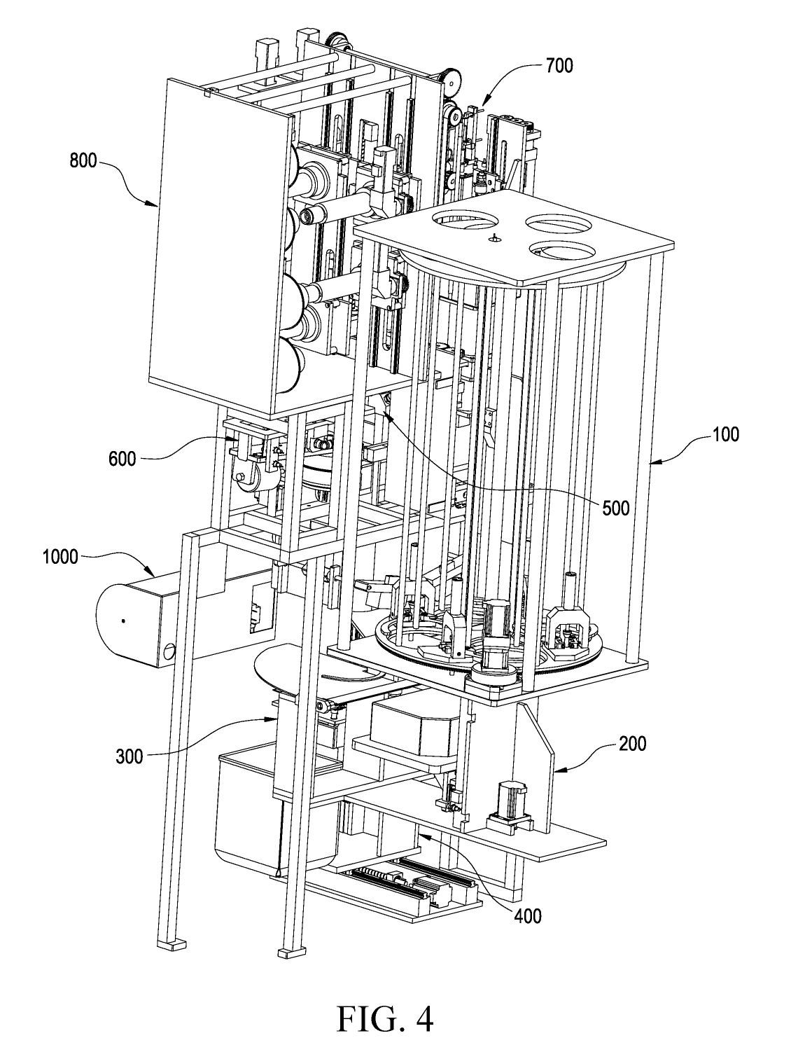

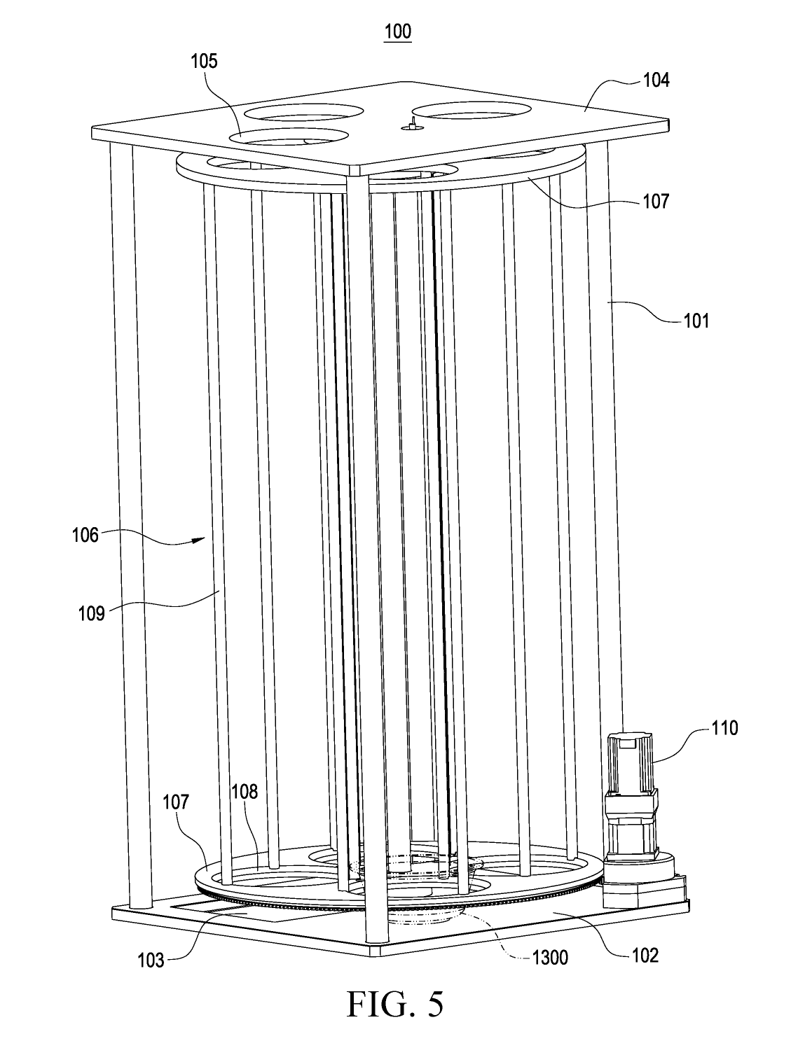

Please refer to FIGS. 1-4, which are the right front perspective view, the left front perspective view, the right rear perspective view, and the left rear perspective view of the internal structure of the noodle vending machine of the present invention, respectively. Please also refer to FIGS. 5-16, each of which is the perspective view of a single mechanism of the present invention. As shown in FIGS. 1-16, the noodle vending machine of the present invention comprises a rotary noodle selector 100, a noodle picking mechanism 200, a bowl transfer mechanism 300, an X-Y axis noodle provider 400, a soup injection mechanism 500, an automatic steam adding mechanism 600, a heating-and-mixing mechanism 700, a soup base compressing mechanism 800, a soup base fixed quantity provider 900, a chopstick provider 1000, and a panel driving mechanism 1100. First, the customer orders the noodles through a human-machine interface (not shown) of the noodle vending machine. Then, the rotary noodle selector 100 rotates out the noodle bowl 1300 with the cooked noodles. The noodle picking mechanism 200 takes out the noodle bowl 1300 which is then carried to the X-Y axis noodle provider 400 through the bowl transfer mechanism 300. After that, the X-Y axis noodle provider 400 sends the noodle bowl 1300 to the soup injection mechanism 500 for the thawing process and injects the soup into the noodle bowl 1300. Thus, the noodles are available to the customer.

The rotary noodle selector 100 is installed in a refrigerator (not shown) of the noodle vending machine and has a fixture 101 having a lower fixing plate 102 and an upper fixing plate 104. The lower fixing plate 102 has an outlet 103 for outputting the noodle bowl 1300; the upper fixing plate 104 has a plurality of inlets 105 for the entry of the noodle bowl 1300. The fixture 101 is pivoted to a rotary set 106 having two rotary disks 107. The two rotary disks 107 individually have a plurality of throughholes 108 corresponding to each other. A plurality of positioning rods 109 is disposed on the perimeters of the throughholes 108 to form a plurality of spaces for accommodating the noodle bowl 1300. In addition, a step motor 110 is disposed on the lower fixing plate 102 and connected to a gear (not shown) engaged with a gear surface (not shown) on the perimeter of the lower rotary disk 107 such that the gear rotates the rotary disk 107 to rotate the rotary set 106, as shown in FIG. 5.

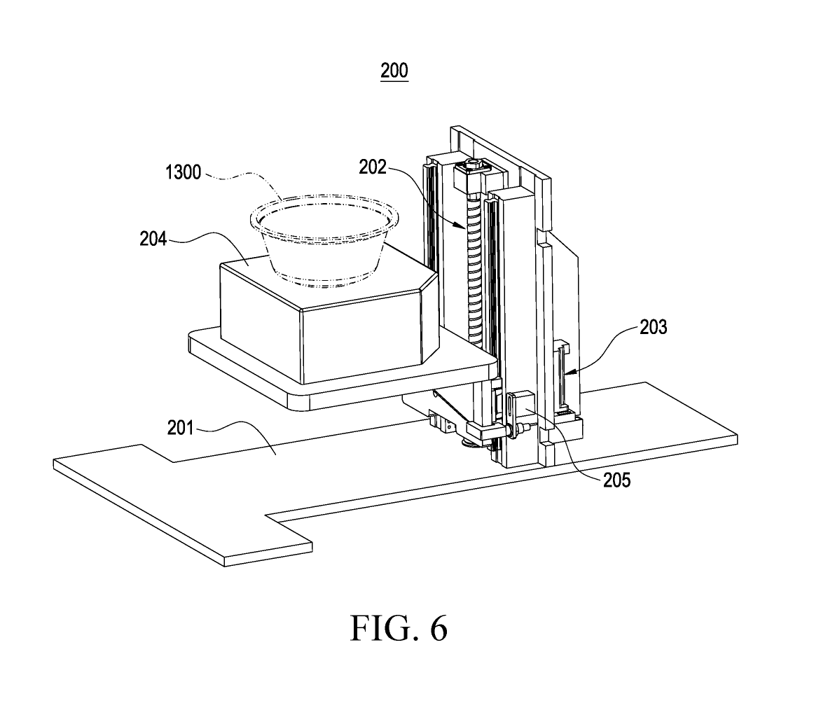

The noodle picking mechanism 200, disposed below the rotary noodle selector 100, has a bottom plate 201 on which a transmission set 202 and a step motor 203 are disposed. A supporting platform 204 is pivoted to the transmission set 202 such that the transmission set 202 drives the supporting platform 204 to move vertically through the rotation of the step motor 203. Besides, a sensor 205 is disposed at a side of the transmission set 202 to sense a position signal when the supporting platform 204 is positioned. The position signal is transmitted to a computer end (not shown) which then stops driving the step motor 203, as shown in FIG. 6.

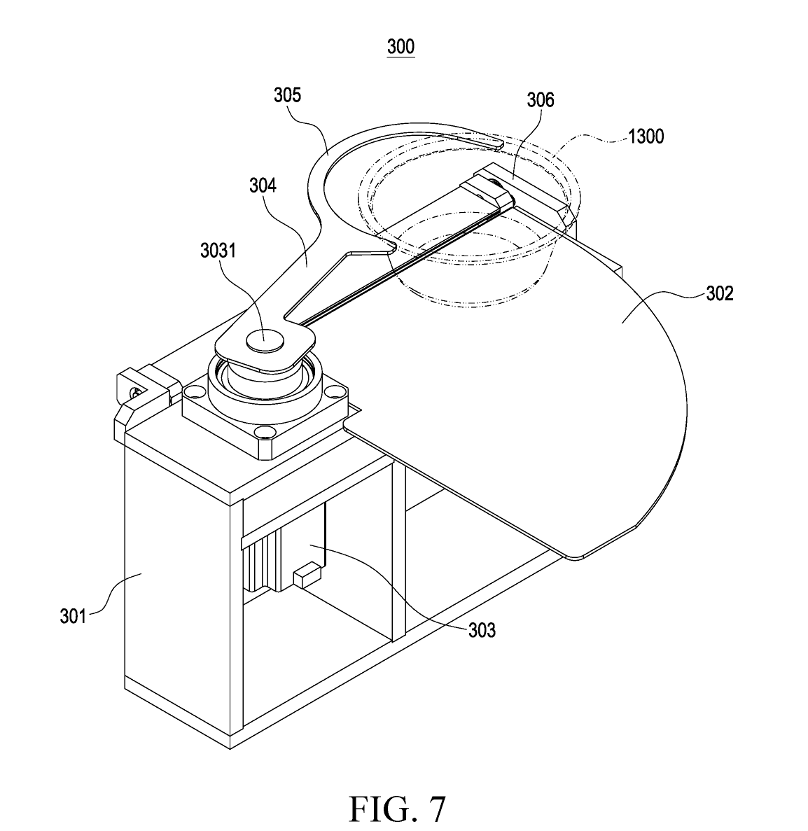

The bowl transfer mechanism 300, disposed at a side of the noodle picking mechanism 200, has a fixing frame 301 on which a holding plate 302 is disposed. A step motor 303 is disposed on a side of the fixing frame 301. A rotary arm 304 is connected to a transmission shaft 3031 of the step motor 303; the rotary arm 304 has a hook portion 305 shaped like a sickle. When the control circuit (not shown) of the noodle vending machine drives the step motor 303 to rotate, the step motor 303 drives the rotary arm 304 to rotate such that the noodle bowl 1300 taken out on the supporting platform 204 is hooked to the holding plate 302. After the X-Y axis noodle provider 400 rises, the rotary arm 304 hooks the noodle bowl 1300 to the X-Y axis noodle provider 400, as shown in FIG. 7. Also, a transition mechanism (a magnet restoration) 306, as shown in FIG. 7, is disposed on another side of the fixing frame 301. The function of the transition mechanism 306 is to compensate a gap between the automatic door of the refrigerator and the holding plate 302 such that the noodle bowl 1300 can be moved stably onto the holding plate 302.

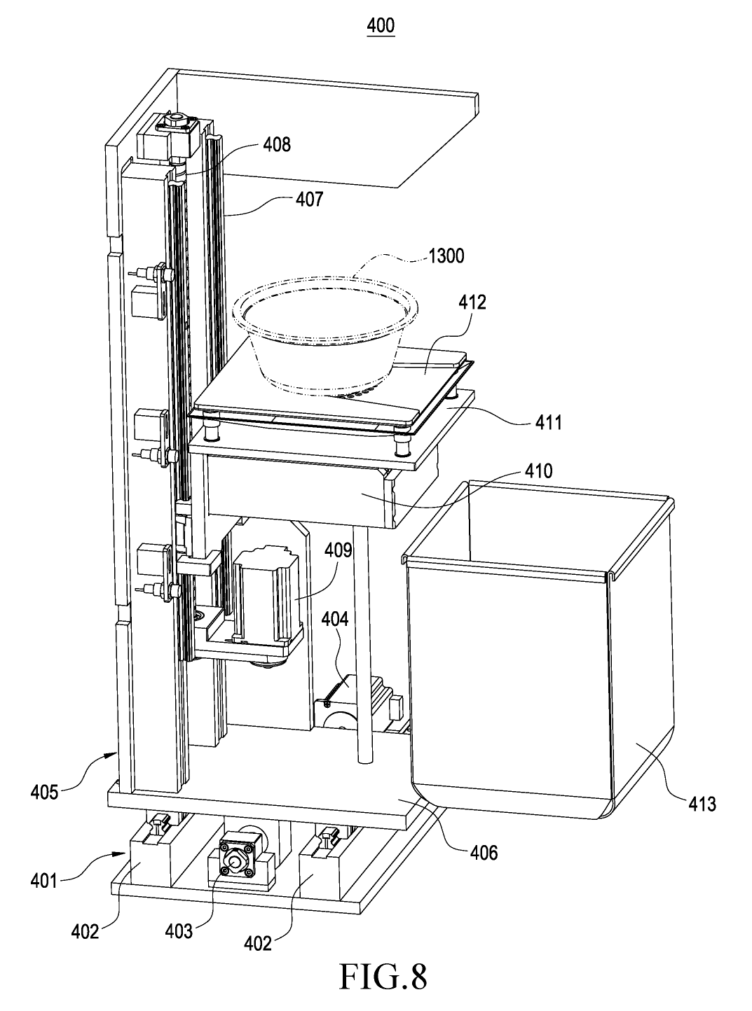

The X-Y axis noodle provider 400, disposed at a side of the bowl transfer mechanism 300, has an X-axis moving mechanism 401 comprising two X-axis linear guides 402. An X-axis transmission shaft 403 and an X-axis step motor 404 connected to the X-axis transmission shaft 403 are disposed between the two X-axis linear guides 402 such that the X-axis step motor 404 drives a moving platform 406 of a Y-axis moving mechanism 405 pivoted to the X-axis transmission shaft 403. In similar, the Y-axis moving mechanism 405 comprises two Y-axis linear guides 407 between which a Y-axis transmission shaft 408 and a Y-axis step motor 409 connected to the Y-axis transmission shaft 408 are disposed. A supporting plate 410 is pivoted to the Y-axis transmission shaft 408 and has a water collecting funnel 411 thereon. A plate-like filter 412, made of stainless steel, is disposed on the water collecting funnel 411. When the soup is injected into the noodle bowl 1300, the overflowed soup flows through the plate-like filter 412 and is guided through the water collecting funnel 411 and then collected to a bucket 413. In addition, a plurality of sensors 414 are disposed at a side of the Y-axis linear guide 407 to sense an up-location or a down-location of the supporting plate 410, as shown in FIG. 8.

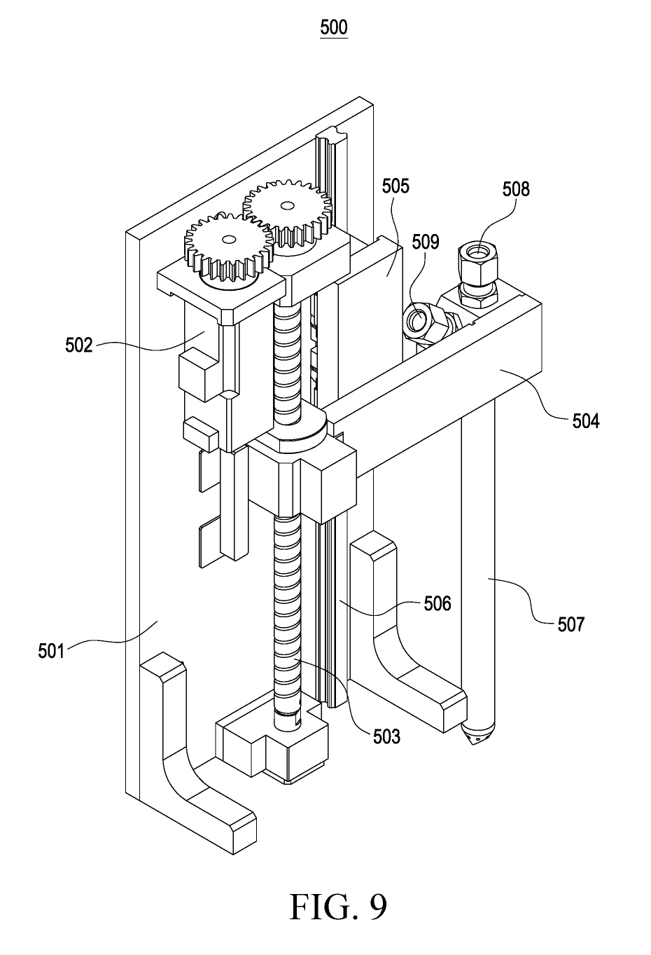

The soup injection mechanism 500, located above the X-Y axis noodle provider 400, has a fixing plate 501. A servo motor 502 and a transmission shaft 503 driven by the servo motor 502 are disposed on a side of the fixing plate 501. The transmission shaft 503 is pivoted to a moving block 504 and a sliding block 505 is attached to a side of the moving block 504. The sliding block 505 is pivoted to a linear track 506 and an injection pipe 507 is attached to the moving block 504. A soup base connector 508 and a steam connector 509 are disposed at one end of the injection pipe 507 such that when the servo motor 502 drivers the transmission shaft 503, the moving block 504 moves the injection pipe 507 vertically. When the soup base or steam is injected into the injection pipe 507, the injection pipe 507 can inject the steam or the soup base into the noodle bowl 1300, as shown in FIG. 9.

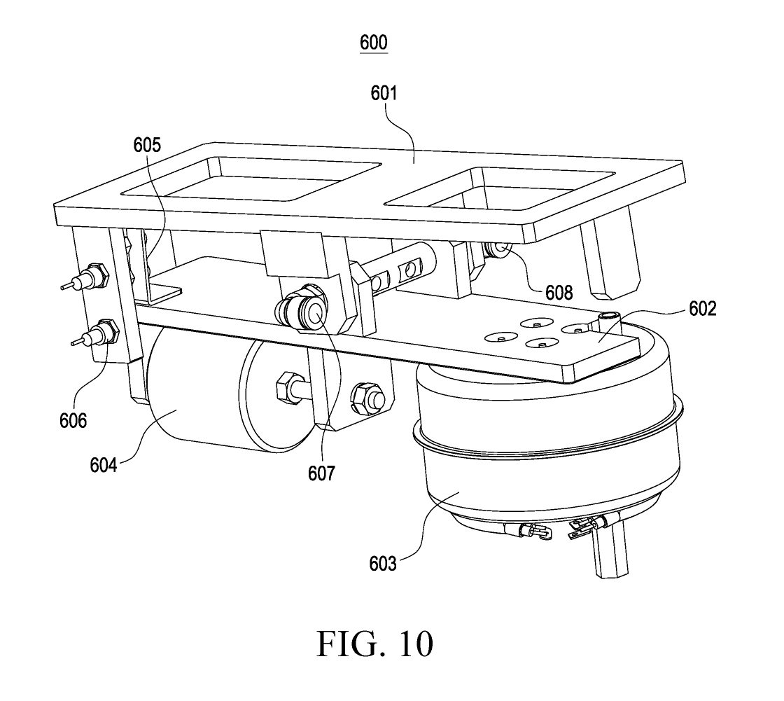

The automatic steam adding mechanism 600, disposed at a side of the soup injection mechanism 500, has a holding plate 601 on which a balance plate 602 is disposed. A steam can 603 is disposed at one end of a side of the balance plate 602 and a counterweight 604 is disposed at the other end of the side of the balance plate 602. A trigger plate 605 is disposed on another side of the balance plate 602 and corresponds to a sensing switch 606 on the holding plate 601. Also, an overpressure vent 607 and a water addition connector 608 are further disposed on the holding plate 601. Pure water flows into the steam can 603 to generate the high-temperature steam rapidly and the steam is then delivered to the steam connector 509 of the injection pipe 507 of the soup injection mechanism 500 such that the injection pipe 507 can inject the steam into the noodle bowl 1300. When the water in the steam can 603 is insufficient, the balance plate 602 will deflect and the trigger plate 605 on the balance plate 602 will trigger the sensing switch 606 such that the high-pressure water pump (not shown) injects water into the steam can 603. When the balance plate 602 restores the equilibrium, the water-adding process of the steam can 603 completes automatically, as shown in FIG. 10.

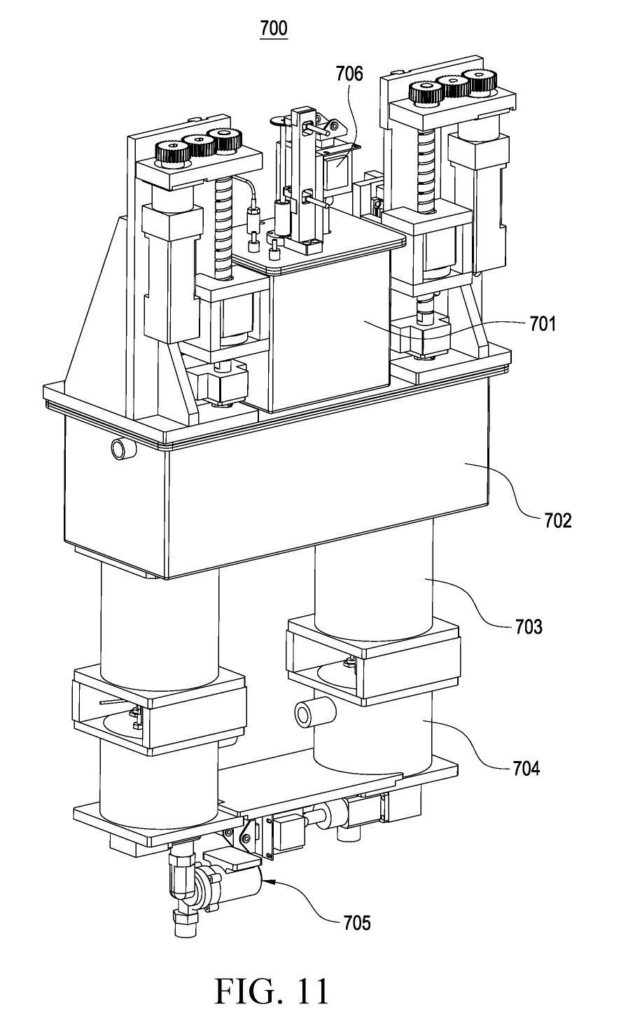

The heating-and-mixing mechanism 700, disposed on another side of the soup injection mechanism 500, comprises at least a heater 701, a warm can 702, a fixed quantity can 703, a mixing can 704, a mixing motor 705, and a solenoid valve 706, as shown in FIG. 11. Pure water is injected into the heater (a boiling water can) 701 through the water pump and is then heated instantly to 100° C. Then, the boiled water is injected into the warm can (a constant-temperature water storage can) 702 by opening a solenoid valve 706 and is kept at a temperature ranging from 95° C. to 98° C. When the customer selects the noodles, the corresponding soup base is immediately pumped into the mixing can 704 and mixed with the boiled water using the mixing motor 705 to make the soup base and the boiled water mixed well. After the noodles are thawed and cooked by high-temperature steam, the mixed soup is instantly injected into the noodle bowl 1300.

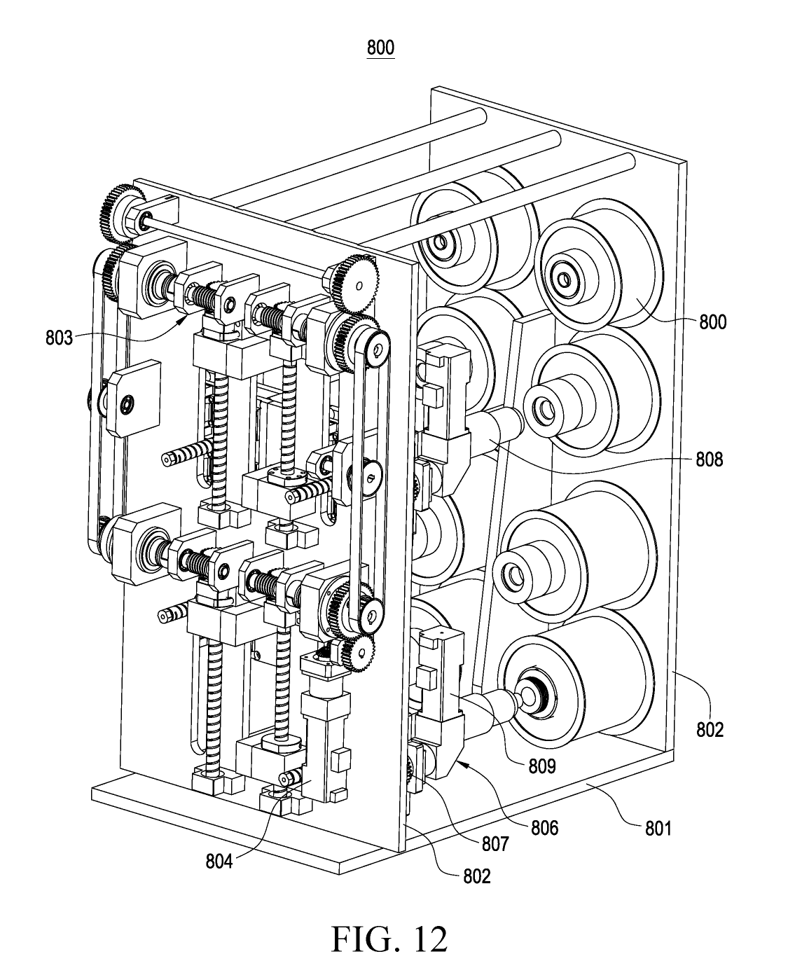

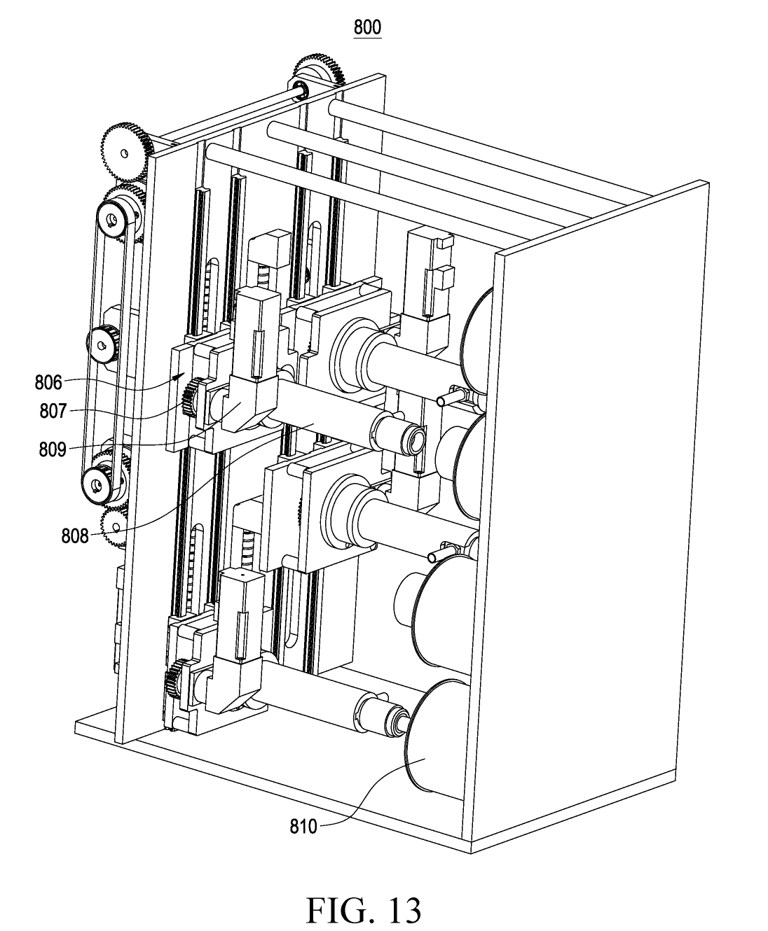

The soup base compression mechanism 800, disposed at a side of the heating-and-mixing mechanism 700 and connected to the heating-and-mixing mechanism 700, has a frame 801 on which two opposite side plates 802 are disposed. A transmission mechanism 803 and a servo motor 804 are disposed on the outer side of one of the two opposite side plates 802 such that the servo motor 804 drives the transmission mechanism 803 to move a plurality of soup stretchable mechanisms 806 on the inner side of the one of the two opposite side plates 802 along liner tracks 805. Each of the soup stretchable mechanisms 806 has a transmission gear 807, a stretchable tube 808, and a servo motor 809. When the transmission mechanism 803 moves and positions one of the soup stretchable mechanisms 806, the servo motor 809 of the positioned soup stretchable mechanism 806 drives the transmission gear 807 to cause the stretchable tube 808 to stretch to press against a soup base can 810 on the other of the two opposite side plates 802 such that the soup base in the soup base can 810 is outputted and injected into the mixing can 704, as shown in FIGS. 12 and 13.

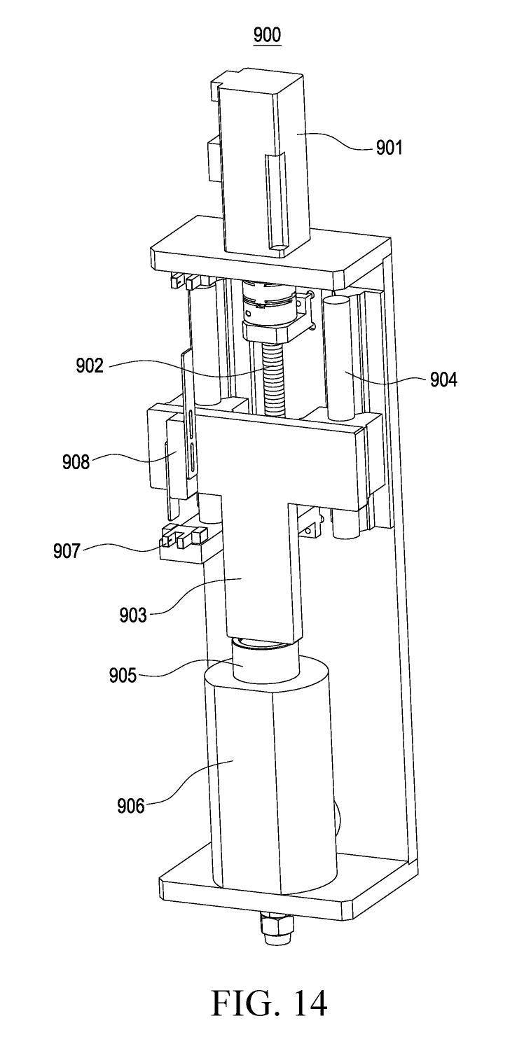

The soup base fixed quantity provider 900, disposed at a side of the soup base compressing mechanism 800 and connected to the heating-and-mixing mechanism 700, has a servo motor 901 driving a screw shaft 902 to slide a press block 903 on a linear guide 904 such that one end of the press block 903 pushes a press rod 905 which squeezes the seasoning out of a seasoning can 906 to the mixing can 704. Due to variety of noodles and customers' demands for flavors, the soup base fixed quantity provider 900 can adjust the amount of the soup base accordingly. Besides, an inductive switch 907 is disposed at a side of the press rod 905 such that when the press rod 905 moves and a top stopper 908 on the press rod 905 triggers the inductive switch 907, the servo motor stops 901, as shown in FIG. 14.

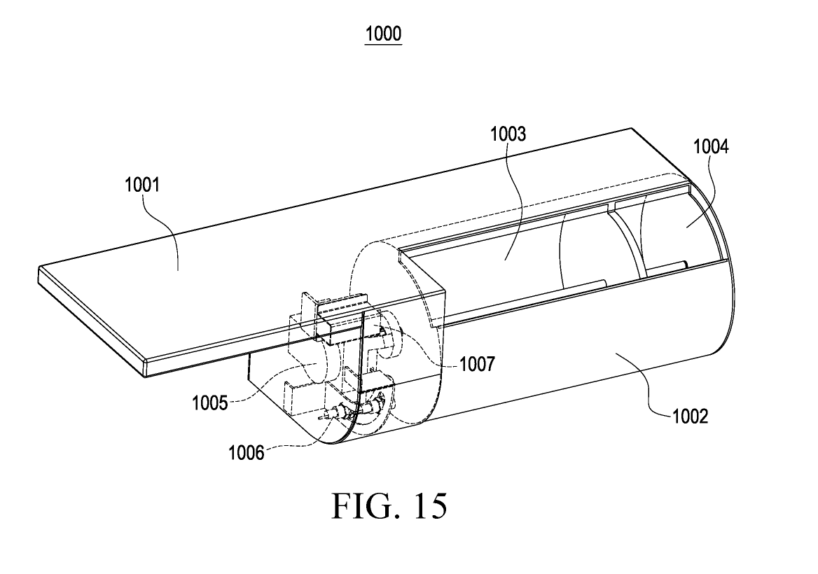

The chopstick provider 1000, disposed at a side of the bowl outlet, has a stainless steel platform 1001 with a rotary store tank 1002 in which a chopstick area 1003 and a seasoning bag area 1004 are disposed. An electrical guider 1005 rotating the rotary store tank 1002, a position sensor 1006 sensing the rotary position of the rotary store tank 1002, and an electronic lock 1007 locking the rotary store tank 1002 are disposed inside the platform 1001. When the customer decides to purchase the noodles, the electrical guider 1005 of the chopstick provider 1000 rotates out the rotary store tank 1002 which is then positioned through the position sensor 1006. After the customer takes out the chopsticks and the seasoning bag, the electrical guider 1005 rotates the rotary store tank 1002 back to its original position to close the rotary store tank 1002 automatically, as shown in FIG. 15.

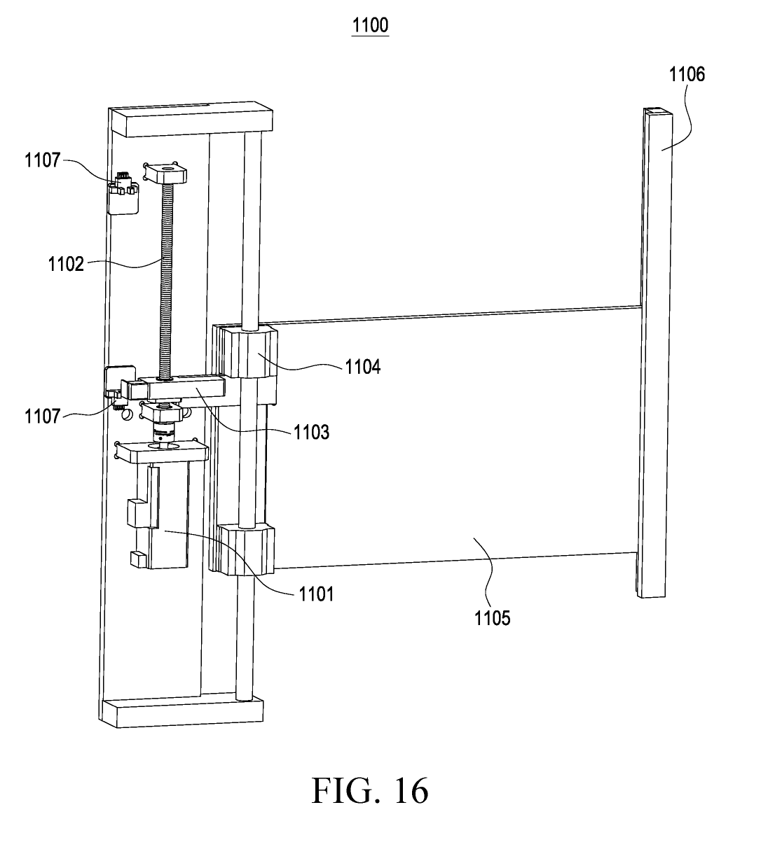

The panel driving mechanism 1100, disposed at a side of the bowl outlet of the noodle vending machine, has a servo motor 1101 driving a screw shaft 1102 which drives a contact arm 1103. One end of the contact arm 1103 presses against a linear bearing 1104 such that the linear bearing 1104 moves a panel 1105 vertically along a track bearing 1106. Also, two opposite inductive switches 1107 are disposed beside the screw shaft 1102 to sense a position signal when the contact arm 1103 moves vertically, and then the servo motor 1101 stops driving the screw shaft 1102 based on the position signal. When the noodles have been cooked already, the panel 1105 is driven to open automatically to allow the customer to take out the noodle bowl 1300. Because the panel driving mechanism 1100 uses closed-loop-torsion as the circuit control, when the customer's hand has not been withdrawn, the internal circuit (not shown) of the noodle vending machine will detect an abnormal signal of the torque of the servo motor 1101. Thus, the panel 1105 will open again automatically until the customer's hand leave the panel 1105 completely, as shown in FIG. 16.

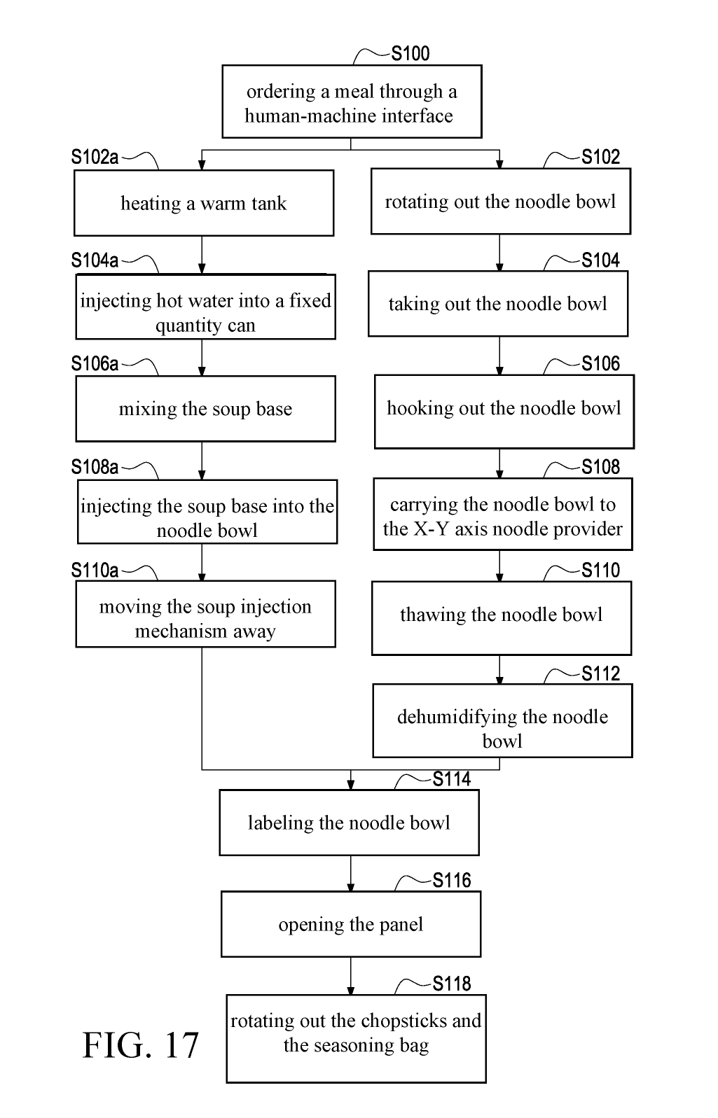

Please refer to FIG. 17, which is the flowchart of the control method of the noodle vending machine of the present invention, as well as refer to FIGS. 1-16, each of which is a single mechanism in the noodle vending machine. First, the customer orders a meal before the noodle vending machine through a human-machine interface (not shown), referring to step S100. After the customer selects the noodles displayed on the human-machine interface, the noodle vending machine will perform two simultaneous step sequences.

In step S102 of rotating out the noodle bowl, the noodle bowl 1300 selected by the customer is rotated out through the rotary noodle selector 100.

In step S104 of taking out the noodle bowl, after step S102 of rotating out the noodle bowl 1300, the noodle bowl 1300 is taken out through the noodle picking mechanism 200.

In step S106 of hooking out the noodle bowl, after step S104 of taking out the noodle bowl 1300, the noodle bowl 1300 is hooked out through the hook portion 305, shaped like a sickle, of the rotary arm 304.

In step S108 of carrying the noodle bowl to the X-Y axis noodle provider, after step S106 of hooking out the noodle bowl 1300, the noodle bowl 1300 is carried to the X-Y axis noodle provider 400 through the holding plate 302 of the bowl transfer mechanism 300.

In step S110 of thawing the noodle bowl, after step S108 of carrying the noodle bowl 1300 to the X-Y axis noodle provider 400, the noodle bowl 1300 is lifted through the X-Y axis noodle provider 400, simultaneously the soup injection mechanism 500 is lowered above the noodle bowl 1300, the automatic steam adding mechanism 600 sends steam to the soup injection mechanism 500 and then to the steam connector 509 of the injection pipe 507, and the cooked noodles in the noodle bowl 1300 is thawed.

In step S112 of dehumidifying the noodle bowl, after step S110 of dehumidifying the noodle bowl 1300, a dehumidifier is used to remove the moisture in the noodle bowl 1300.

After step S102 of rotating out the noodle bowl, a simultaneous step S102a of heating a warm tank is performed in which pure water is injected into a heater 701 of the heating-and-mixing mechanism 700 through a water pump and is heated instantly to 100° C. which is injected into the warm tank 702 by opening a solenoid valve 706 and is kept at a temperature ranging from 95° C. to 98° C.

In step S104a of injecting hot water into a fixed quantity can, when the soup base is being made, hot water is injected into the fixed quantity can 703 of the heating-and-mixing mechanism 700.

In step S106a of mixing the soup base, the soup base compressing mechanism 800 and the soup base fixed quantity provider 900 inject the soup base into the mixing can 704 according to the flavor and the amount of the soup base selected by the customer. Simultaneously, the hot water in the fixed quantity can 703 is injected into the mixing can 704. At this moment, the hot water and the soup base in the mixing can 704 is mixed by starting a mixing motor 705.

In step S108a of injecting the soup base into the noodle bowl, after the soup base is mixed, the soup base is sent to the soup base connector 508 of the injection pipe 507 of the soup injection mechanism 500 and then is injected into the noodle bowl 1300 through the injection pipe 507.

In step S110a of moving the soup injection mechanism away, after the soup base is injected into the noodle bowl 1300, the soup injection mechanism 500 is restored.

In step S114 of labeling the noodle bowl, after the soup base is injected into the noodle bowl 1300, the X-Y axis noodle provider 400 carries the noodle bowl 1300 to the bowl outlet where the labeling mechanism 1200 labels the noodle bowl 1300.

In step S116 of opening the panel, after the noodle bowl 1300 is labeled, the servo motor 1101 of the panel driving mechanism 1100 drives the screw shaft 1102 such that the contact arm 1103 presses against the linear bearing 1104 to lift the panel 1105 to allow the customer to take out the noodle bowl 1300.

In step S118 of rotating out the chopsticks and the seasoning bag, when the noodle bowl 1300 is sent to the bowl outlet, the electrical guide 1005 of the chopstick provider 1000 rotates out the rotary store tank 1002 which is positioned by the position sensor 1006. After the customer takes out the chopsticks and the seasoning bag, the electrical guide 1005 rotates the rotary store tank 1002 back to its original position to close the rotary store tank 1002 automatically.

The embodiments described above are only preferred ones of the present invention and are not to limit the scope of the present invention. All the equivalent modifications and variations applying the specification and figures of the present invention should be embraced by the claimed scope of the present invention.

What is claimed is:

1. A control method of a noodle vending machine comprising a rotary noodle selector, a noodle picking mechanism, a bowl transfer mechanism, an X-Y axis noodle provider, a soup injection mechanism, an automatic steam adding mechanism, a heating-and-mixing mechanism, a soup base compressing mechanism, and a soup base fixed quantity provider, the control method, which is used to steam a noodle bowl, comprising the steps of:
(a) rotating out the noodle bowl through the rotary noodle selector;
(b) taking out the noodle bowl through the noodle picking mechanism after the noodle bowl is rotated out;
(c) hooking out the noodle bowl through the bowl transfer mechanism;
(d) carrying the noodle bowl to the X-Y axis noodle provider after the noodle bowl is hooked out;
(e) lifting the noodle bowl through the X-Y axis noodle provider, simultaneously lowering the soup injection mechanism above the noodle bowl, sending steam to the soup injection mechanism through the automatic steam adding mechanism and then thawing the noodle bowl through the soup injection mechanism;
(f) heating a warm tank of the heating-and-mixing mechanism;
(g) injecting hot water into a fixed quantity can of the heating-and-mixing mechanism;
(h) injecting soup base into a mixing can of the heating-and-mixing mechanism through the soup base compressing mechanism and the soup base fixed quantity provider according to the selected flavor and amount of the soup base, injecting the hot water in the fixed quantity can into the mixing can, and mixing the hot water and the soup base in the mixing can by starting a mixing motor of the heating-and-mixing mechanism; and
(i) sending the soup base to the soup injection mechanism after the soup base is mixed and injecting the soup base into the noodle bowl through the soup injection mechanism,
wherein the steps (f), (g), (h), and (i) are performed in parallel with the steps of (a), (b), (c), (d), and (e).

2. The control method according to claim 1, after the step (e), further comprising the step of dehumidifying the noodle bowl, wherein a dehumidifier is used to remove the moisture in the noodle bowl after the noodle bowl is thawed.

3. The control method according to claim 1, wherein in the step (f) pure water is injected into a heater of the heating-and-mixing mechanism through a water pump and is heated instantly to 100° C. which is injected into the warm tank by opening a solenoid valve and is kept at a temperature ranging from 95° C. to 98° C.

4. The control method according to claim 1, after the step (i), further comprising the step (j) of restoring the soup injection mechanism after the soup base is injected into the noodle bowl.

5. The control method according to claim 4, after the step (j), further comprising the step (k) of labeling the noodle bowl using a labeling mechanism after the noodle bowl is injected with the soup base and is then carried to a bowl outlet by the X-Y axis noodle provider.

6. The control method according to claim 5, after the step (k), further comprising the step (1) of driving a panel to open using a panel driving mechanism after the noodle bowl is labeled.

7. The control method according to claim 6, after the step (1), further comprising the step (m) of rotating out chopsticks and a seasoning bag using a chopstick provider when the noodle bowl is carried to the bowl outlet.

8. A noodle vending machine used to steam a noodle bowl, comprising:
a rotary noodle selector installed in a refrigerator of the noodle vending machine;
a noodle picking mechanism disposed below the rotary noodle selector;
a bowl transfer mechanism disposed at a side of the noodle picking mechanism;
an X-Y axis noodle provider disposed at a side of the bowl transfer mechanism;
a soup injection mechanism located above the X-Y axis noodle provider;
an automatic steam adding mechanism disposed at a side of the soup injection mechanism and connected to the soup injection mechanism;
a heating-and-mixing mechanism disposed at another side of the soup injection mechanism and connected to the soup injection mechanism;
a soup base compressing mechanism disposed at a side of the heating-and-mixing mechanism and connected to the heating-and-mixing mechanism; and
a soup base fixed quantity provider disposed at a side of the soup base compressing mechanism and connected to the heating-and-mixing mechanism,
wherein the noodle picking mechanism takes out the noodle bowl rotated out by the rotary noodle selector, wherein the bowl transfer mechanism hooks the noodle bowl to the X-Y axis noodle provider, wherein the X-Y axis noodle provider lifts the noodle bowl and simultaneously the soup injection mechanism moves downward, wherein the automatic steam adding mechanism sends steam to the soup injection mechanism to thaw the noodle bowl, wherein the soup base compressing mechanism and the soup base fixed quantity provider inject soup base into the heating-and-mixing mechanism for mixing when the heating-and-mixing mechanism is heated and then the heating-and-mixing mechanism sends the soup base to the soup injection mechanism which injects the soup base into the noodle bowl.

9. The noodle vending machine according to claim 8, wherein the rotary noodle selector has a fixture having a lower fixing plate and an upper fixing plate, wherein the lower fixing plate has an outlet and the upper fixing plate has a plurality of inlets, wherein the fixture is pivoted to a rotary set having two rotary disks, wherein the two rotary disks individually have a plurality of throughholes corresponding to each other, wherein a plurality of positioning rods are disposed on the perimeters of the throughholes to form a plurality of spaces for accommodating the noodle bowl, wherein a step motor is disposed on the lower fixing plate and connected to a gear engaged with a gear surface on the perimeter of the rotary disk under the rotary set such that the gear drives the gear surface of the rotary disk to rotate the rotary set.

10. The noodle vending machine according to claim 8, wherein the noodle picking mechanism has a bottom plate on which a transmission set and a step motor are disposed, wherein a supporting platform is pivoted to the transmission set such that the transmission set drives the supporting platform to move vertically through the rotation of the step motor, wherein a sensor is disposed at a side of the transmission set to sense a position signal when the supporting platform is positioned.

11. The noodle vending machine according to claim 8, wherein the bowl transfer mechanism has a fixing frame on which a holding plate is disposed, wherein a step motor is disposed on a side of the fixing frame and a rotary arm is connected to a transmission shaft of the step motor, wherein the rotary arm has a hook portion shaped like a sickle and the rotary arm is driven and rotated by the step motor such that the noodle bowl on the supporting platform is hooked to the holding plate and then to the X-Y axis noodle provider, wherein a transition mechanism is disposed on another side of the fixing frame.

12. The noodle vending machine according to claim 8, wherein the X-Y axis noodle provider has an X-axis moving mechanism comprising two X-axis linear guides, wherein an X-axis transmission shaft and an X-axis step motor connected to the X-axis transmission shaft are disposed between the two X-axis linear guides such that the X-axis step motor drives a moving platform of a Y-axis moving mechanism pivoted to the X-axis transmission shaft, wherein the Y-axis moving mechanism comprises two Y-axis linear guides between which a Y-axis transmission shaft and a Y-axis step motor connected to the Y-axis transmission shaft are disposed, wherein a supporting plate is pivoted to the Y-axis transmission shaft and has a water collecting funnel thereon, wherein a plate-like filter is disposed on the water collecting funnel and a bucket is disposed at a side of the water collecting funnel, wherein a plurality of sensors are disposed at a side of the Y-axis linear guide to sense an up-location or a down-location of the supporting plate.

13. The noodle vending machine according to claim 8, wherein the soup injection mechanism has a fixing plate, wherein a servo motor and a transmission shaft driven by the servo motor are disposed on a side of the fixing plate, wherein the transmission shaft is pivoted to a moving block and a sliding block is attached to a side of the moving block, wherein the sliding block is pivoted to a linear track and an injection pipe is attached to the moving block, wherein a soup base connector and a steam connector are disposed at one end of the injection pipe such that when the servo motor drivers the transmission shaft, the moving block moves the injection pipe vertically.

14. The noodle vending machine according to claim 8, wherein the automatic steam adding mechanism has a holding plate on which a balance plate, an overpressure vent, and a water addition connector are disposed, wherein a steam can is disposed at one end of a side of the balance plate and a counterweight is disposed at the other end of the side of the balance plate, wherein a trigger plate is disposed on another side of the balance plate and corresponds to a sensing switch on the holding plate.

15. The noodle vending machine according to claim 8, wherein the heating-and-mixing mechanism comprises at least a heater, a warm can, a fixed quantity can, a mixing can, a mixing motor, and a solenoid valve.

16. The noodle vending machine according to claim 8, wherein the soup base compression mechanism has a frame on which two opposite side plates are disposed, wherein a transmission mechanism and a servo motor are disposed on the outer side of one of the two opposite side plates such that the servo motor drives the transmission mechanism to move a plurality of soup stretchable mechanisms on the inner side of the one of the two opposite side plates along liner tracks, wherein each of the soup stretchable mechanisms has a transmission gear, a stretchable tube, and a servo motor, wherein when the transmission mechanism moves and positions one of the soup stretchable mechanisms, the servo motor of the positioned soup stretchable mechanism drives the transmission gear to cause the stretchable tube to stretch to press against a soup base can on the other of the two opposite side plates such that the soup base in the soup base can is outputted and injected into the heating-and-mixing mechanism.

17. The noodle vending machine according to claim 8, wherein the soup base fixed quantity provider has a servo motor driving a screw shaft to slide a press block on a linear guide such that one end of the press block pushes a press rod which squeezes seasoning out of a seasoning can to the heating-and-mixing mechanism, wherein an inductive switch is disposed at a side of the press block such that when the press block moves and a top stopper on the press block triggers the inductive switch, the servo motor stops.

18. The noodle vending machine according to claim 8, further comprising a chopstick provider disposed at a side of a bowl outlet of the noodle vending machine and having a stainless steel platform with a rotary store tank in which a chopstick area and a seasoning bag area are disposed, wherein an electrical guider rotating the rotary store tank, a position sensor sensing the rotary position of the rotary store tank, and an electronic lock locking the rotary store tank are disposed inside the platform.

19. The noodle vending machine according to claim 8, further comprising a panel driving mechanism disposed at a side of a bowl outlet of the noodle vending machine and having a servo motor driving a screw shaft which drives a contact arm, wherein one end of the contact arm presses against a linear bearing such that the linear bearing moves a panel vertically along a track bearing, wherein two opposite inductive switches are disposed beside the screw shaft to sense a position signal when the contact arm moves vertically and then the servo motor stops driving the screw shaft based on the position signal.

20. The noodle vending machine according to claim 8, further comprising a labeling mechanism which labels the noodle bowl when the noodle bowl is carried to a bowl outlet by the X-Y axis noodle provider.
